(19) United States
(12) Patent Application Publication
(10) Pub. No.: US 2002/0029168 A1
(43) Pub. Date: Mar. 7, 2002

(54) On-line product searching method and apparatus

(76) Inventors: Richard S. McConnell JR., Huntersville, NC (US); Ramkin Shetty, Mangalore (IN); Mark C. Rohrwasser, Mooresville, NC (US); Aaron M. Linz, Charlotte, NC (US)

Correspondence Address: Hunton & Williams, 1900 K Street, N.W., Washington, DC, 20006-1109, US

(21) Appl. No.: 09/750,917

(22) Filed: Jan. 2, 2001

Related U.S. Application Data
(60) Provisional application No. 60/173,714, filed on Dec. 30, 1999.

(51) Int. Cl. G06F 17/60

(52) U.S. Cl. 705/26

(57) ABSTRACT

A method and apparatus for searching for products in an on-line purchasing system. Searches can be conducted in a variety of ways. For example, searches can be conducted based on a manufacturer, a type of product, or by product characteristics. The search method and apparatus is particularly well suited for searching bulk industrial products.

### CROSS REFERENCE TO RELATED APPLICATIONS

This application claims the benefit of provisional patent application Ser. No. 60/173,714, filed Dec. 30, 1999, the disclosure of which is incorporated herein by reference.

### BACKGROUND OF THE INVENTION

The present invention relates generally to conducting electronic commercial transactions on-line, i.e. over a computer network. More particularly, the present invention relates to a method an apparatus for searching for products in an on-line system.

Recent advances in communication, the Internet in particular, have facilitated on-line commerce by exposing purchasers to more information relating to vendors and the goods for sale by the vendors. The Internet is a worldwide network of computers linked together by various hardware communication links all running a standard suite of protocols known as TCP/IP (transmission control protocol/Internet protocol). The growth of the Internet over the last several years has been explosive, fueled in the most part by the widespread use of software viewers known as browsers and HTTP (hypertext transfer protocol) which allow a simple graphical user interface (GUI) to communicate over the Internet. Browsers generally reside on the computer used to access the Internet, i.e. the client computer. HTTP is a component of TCP/IP and provides users access to files of various formats using a standard page description language known as HTML (hypertext markup language). The collection of servers on the Internet using HTTP has become known as the “World Wide Web” or simply the “Web”.

Through HTML, and interactive programming protocols, the author of a particular web page, or pages, is able to make information available to viewers of the web page by placing the web pages on an Internet web server in HTML format. The network path to the server is identified by a URL (Uniform Resource Locator) and, generally, any client running a web browser can access the web pages by the URL.

The Web has become ubiquitous in businesses and homes because it has proven to be convenient for various applications, such as news and data delivery, conducting banking and investment transactions, and the like. The Web and its authoring, transmission, and display protocols, such as browsers, HTML, CGI, Active Server Pages™, and Java™, have become a worldwide standard for information exchange.

Further, the Web has become a primary vehicle for purchasing goods and services. The increased speed at which information is exchanged and purchases are made has the potential to render markets more efficient. It is well known to use various searching software, known as “search engines”, for locating products in on-line purchasing systems. However, there are many types of transactions to which known search engines offer little or no practical utility. For example, purchasers of bulk items for industrial or other uses, such as chemicals, are not efficiently accommodated by conventional search engines.

Therefore, there is a need for a search methodology for enabling purchasers of bulk materials or other specialized goods to efficiently and accurately identify particular products.

### BRIEF SUMMARY OF THE INVENTION

The present invention overcomes the problems noted above, and provides additional advantages, by providing a method and system for enabling improved searching for products in an on-line purchasing system. Searches can be conducted in a variety of ways. For example, searches can be conducted based on a manufacturer, a type of product, or by product characteristics. The search method and apparatus is particularly well suited for searching bulk industrial products or other specialty goods. A server computer receives, from a client computer associated with a user, a search products request. In response to this request, the server computer displays a search page having thereon a plurality of search options. The purchaser may then utilize any of the available search options to locate a particular product for purchase. Preferred search options include a product name search, a manufacturer search, a resin type search, and a region search. By providing varied, easy to user, search techniques, purchasers having different kinds of information are more easily enabled to locate specific products for purchase.

### BRIEF DESCRIPTION OF THE DRAWINGS

The present invention can be understood more completely by reading the following Detailed Description of exemplary embodiments, in conjunction with the accompanying drawings, in which:

FIG. 1 is a block diagram of a computer network suitable for implementing a method and system according to a preferred embodiment of the present invention;

FIG. 2 is a flow chart of a method of conducting commerce using the preferred embodiment;

FIG. 3 is a flow chart describing the search engine option briefly described in FIG. 2;

FIG. 4 is a preferred embodiment of the manufacturer name search page described in FIG. 3;

FIG. 5 is a preferred embodiment of the resin type search page described in FIG. 3; and

FIG. 6 is a preferred embodiment of the product grade selection page described in FIG. 3.

### DETAILED DESCRIPTION OF THE INVENTION

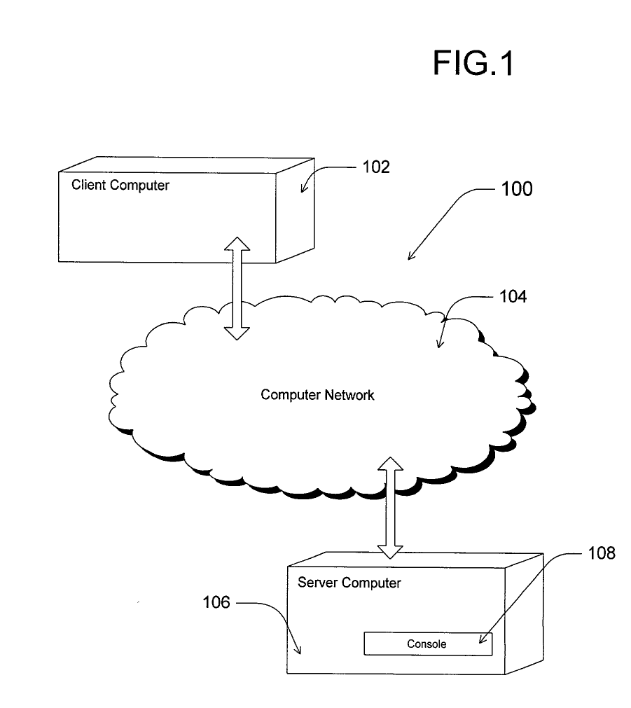

An Internet computer system 100 is generally illustrated in FIG. 1. A conventional client computer system 102, executing a client browser application that supports the HTTP protocol, is connected typically through a network service provider to a suitable computer network 104 such as the Internet.

Client computer system 102 may include, for instance, a personal computer running the Microsoft Windows™ 95, 98, Millenium™, NT™, or 2000, Windows™ CE™, PalmOS™, Unix, Linux, Solaris™, OS/2™, BeOS™, MacOS™ or other operating system or platform. Client computer system 102 may also include a microprocessor such as an Intel x86-based device, a Motorola 68K or PowerPC™ device, a MIPS, Hewlett-Packard Precision™, or Digital Equipment Corp. Alpha™ RISC processor, a microcontroller or other general or special purpose device operating under programmed control. Furthermore, client computer system 102 may include electronic memory such as RAM (random access memory) or EPROM (electronically programmable read only memory), storage devices such as a hard drive, CDROM or rewritable CDROM or other magnetic, optical or other media, and other associated components connected over an electronic bus, as will be appreciated by persons skilled in the art. Client computer system 102 may also include a network-enabled appliance such as a WebTV™ unit, radio-enabled Palm™ Pilot or similar unit, a set-top box, a networkable game-playing console such as Sony Playstation™ or Sega Dreamcast™, a browser-equipped cellular telephone, or other TCP/IP client or other device.

In addition to the Internet, suitable computer networks may also include or interface with any one or more of, for instance, an local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34 bis analog modem connection, a cable modem, an ATM (Asynchronous Transfer Mode) connection, or an FDDI (Fiber Distributed Data Interface) or CDDI (Copper Distributed Data Interface) connection. Furthermore, computer network 104 may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. Computer network 104 may yet further include or interface with any one or more of an RS-232 serial connection, an IEEE-1394 (Firewire) connection, a Fibre Channel connection, an IrDA (infrared) port, a SCSI (Small Computer Systems Interface) connection, a USB (Universal Serial Bus) connection or other wired or wireless, digital or analog interface or connection.

A server computer system 106 is also coupled typically through an Internet Service Provider to the Internet 104. The server computer system 106 may be or include, for instance, a workstation running the Microsoft Windows™ NT™, Windows™ 2000, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. The server computer system 106, controlled by a local console 108, executes at least one web server application conventionally known as a HTTPd server. In addition, the server computer system 106 preferably provides local storage for at least one, though typically many, web pages as files in HTML format and/or other formats. Preferably, a plurality of pricing schedules are also stored in the memory device of server computer system 106. These various pricing schedules are described in additional detail below. Also, server computer system 106 may include several individual server computers at various locations on the network.

The client computer system requests a web page by issuing a URL request through the Internet 104 to the server system 106. A URL consistent with the present invention may be a simple URL of the form:

<protocol_identifier>://<server_path>/<web_page_path>

A “protocol_identifier” of “http” specifies the conventional hyper-text transfer protocol. A URL request for a secure Internet communication session typically utilizes the secure protocol identifier “https,” assuming that the client browser and web server each support and implement the secure sockets layer (SSL). The “server_path” is typically of the form “prefix.domain,” where the prefix is typically “www” to designate a web server and the “domain” is the standard Internet sub-domain.top-level-domain of the server system 106. The optional “web_page_path” is provided to specifically identify a particular hyper-text page maintained by the web server.

In response to a received URL identifying an existing web page, the server system 106 returns the web page, subject to the HTTP protocol, to the client computer system 102. This web page typically incorporates both textural and graphical information including embedded hyper-text links, commonly referred to as hyperlinks, that permit the client user to readily select a next URL for issuance to the Internet 104.

The URL issued from the client system 102 may also be of a complex form that identifies a common gateway interface (CGI) program on a server system 106. Such a HTML hyperlink reference is typically of the form:

<form action=“http://www.vendor.com/cgi-bin/logon.cgi” method=post>

A hyper-text link of this form directs the execution of the logon.cgi program on an HTTP server in response to a client-side selection of the hyperlink. A logon form supported by a logon CGI program is typically used to obtain a client user login name and password to initiate an authenticated session between the client browser and web server for purposes of supporting, for example, a secure purchase transaction or a secure communications session.

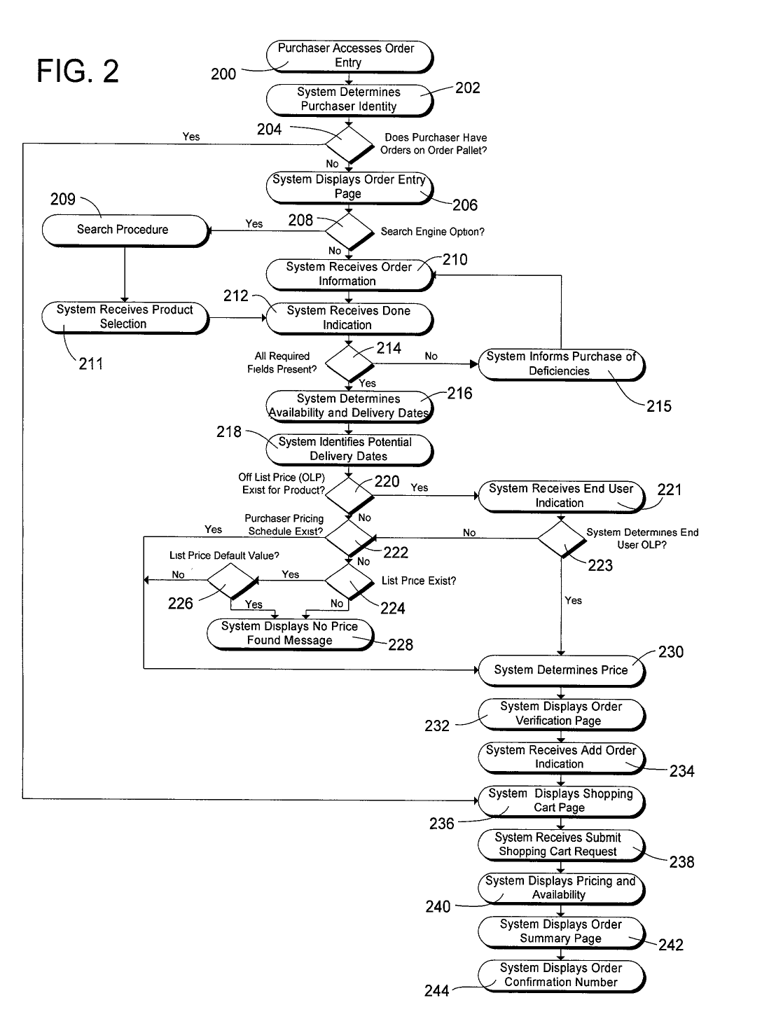

Referring now to FIG. 2 there is shown a flow chart describing one method for processing an order for an product over a computer network, for example the Internet, using the protocols discussed above. This method is preferably implemented by a software program, such as a Web server application, resident in one or more servers (such as the server computer system 106) associated with a supplier. In the preferred embodiment, it is assumed that the client computer system 102 is associated with the purchaser and the server computer system 106 (hereinafter “the system”) is associated with the supplier. It will become apparent below that the party purchasing products is not necessarily the same party as the end user of the products. Accordingly, the term “purchaser” as used herein, refers to the party requesting and/or directing a purchase of products. The phrase “end user” as used herein, refers to the party who will use the product or a product made from the product. The end user and the purchaser can, but need not be, the same. All communication of the preferred embodiment is conducted over the computer network 104 using standard interfaces and protocols. Of course, there can be plural client computer systems 102 and plural server computer systems 106. The server computer system 106 and/or the client computer system 102 can be constituted of plural computers coupled to one another over the computer network 104 or any other communications channel The preferred embodiment assumes the use of a so-called “shopping cart” purchase model, in which a user can select any number of desired products, which are then separately stored as a list (or “cart”) of desired products. When the purchaser is ready to complete the transaction, the list is recalled and the purchaser can then proceed to purchase the products. It will of course be appreciated that other purchasing models may be used.

In step 200, the purchaser accesses an order entry Web page stored on the server computer 106 via the computer network 104 as a network by issuing a URL from the client computer system 102. In step 202, the system determines the identity of the purchaser (from, e.g., the purchaser's login information, (a user name and ID, for example) a previously-established cookie, or other identification information transmitted over the computer network 104). In step 204, the system determined whether the purchaser has any orders currently awaiting processing (e.g., in a “shopping cart” or list of desired products which the purchaser has not yet purchased). If it is determined that the purchaser does have orders awaiting processing, the system proceeds to step 236 described below. However, if it is determined in step 204 that the purchaser does not have any orders awaiting processing, the system continues to step 206, where the system displays an order entry page to the purchaser on the client computer system 102. In this embodiment, the order entry page presents the purchaser using client computer system 102 with the option of using a search engine to locate particular products for purchase.

In step 208, the system determines whether or not the purchaser has selected the search engine function option. If so, the system proceeds to the search procedure in step 209 and described in detail below. If, on the other hand, the system determines that the purchaser has not selected the search engine function option, the system proceeds to step 210, where the system receives purchaser entered purchase information, i.e. information designating products to be purchased. In step 212, the system receives a purchaser indication that they have finished entering the purchase information. If the search engine function was selected in step 208, and products were identified in the search step 209, then in step 211 the system receives an indication as to the products selected by the purchaser from the search results. In step 212, the system receives a purchaser confirmation that they have entered all of the product information.

In step 214, the system determines if all required fields (that is, all information required to process the order) have been entered. If required information is missing, the system informs the purchaser of the deficiencies (e.g., by flagging the fields that require information) in step 215, and the system returns the purchaser to step 210, where additional information can be submitted. If there is no required information missing, the system continues to step 216, where the system examines an inventory database to determine whether the ordered product(s) are presently in inventory, and further determines an estimated delivery date for the ordered product(s). In step 218, the system identifies a list of potential delivery dates or times for the ordered product(s).

In step 220, the system determines whether an off list price (OLP), or other discounted price, is available for one or more of the ordered product(s) based on a pricing schedule for a particular end user. Using the bulk chemical industry for an example, molders may purchase products for use in goods sold to end users at pricing rates pre-negotiated by the end user. In this scenario, even though the molder alone is not eligible for off list pricing, the end user for whom the molder is working enables the materials to be purchased for off list prices. End user pricing schedules having negotiated pricing for the end user and information identifying the end user are preferably stored in at least one database resident on the server computer system. If an end user price schedule exits for any of the products the system continues to step 221 where the purchaser is requested to identify the end user of the product on whose behalf the purchaser is purchasing the product. This step can include entry of an end user code, or other identification information the like to identify the end user in a secure manner. In step 223, the system determines whether the purchaser identified end user is subject to off list pricing for the ordered product(s). In particular, the end user information in the stored end user pricing schedules is compared to the code or other end user identifying data entered in step 221. If the information and data correspond, the appropriated end user pricing schedule is selected. If a specific end user is identified, the process continues to determine a price based on the end user pricing schedule as will be described in more detail below.

If the purchaser is not ordering the product(s) on behalf of an authorized end user, i.e. an end user is not identified the method continues to step 222, where the system determines whether a purchaser pricing schedule, i.e. a price list of prenegotiated prices for the purchaser independent of the end user, exists for one or more of the ordered product(s). In particular, the purchaser identification information entered in step 202 is compared with purchaser pricing schedules stored in server computer system 16. If there is a match, the purchaser pricing schedule is selected and used for pricing. If such a purchaser pricing schedule exists, the method jumps to step 230, where a unit price and price breakdown are determined based on the selected purchaser pricing schedule.

If such a purchaser pricing list is determined not to exist in step 222, then the system continues to step 224, where it is determined whether a list price exists for the ordered product(s). If a list price exists, the system determines whether that list price is a default value (in this example, $99.99) in step 226. If a list price is found not to exist in step 224, or if the list price is found to be a default value, the system, in step 228 displays a message to the purchaser indicating that there is no price found for the product, and the process will end. If a list price is found to exist, and the list price is not a default value, or if the purchaser is purchasing a product on behalf of another end user having an end user pricing schedule (step 223), the system continues to step 230, where a unit price and price bracket are determined based on either the list price, the purchaser pricing schedule, or the end user pricing schedule. Steps 220 through 230 can be accomplished individually for each product or type of product because certain products may be appropriately priced by an end user pricing schedule, while others may be appropriately priced by using a purchaser pricing schedule or list price.

In step 232, the system displays an order verification page to the purchaser, and in step 234, the system receives the purchaser's indication to add the order to a shopping cart (e.g., a stored record of purchases). In step 236, the system displays a shopping cart page (e.g., a list of all desired purchases) to the purchaser, including an option for the purchaser to purchase all products listed on the page. In step 238, the system receives a purchaser selection of the shopping cart, and in step 240, the pricing determined in steps 220 through 230 for each product is displayed and the inventory availability, and delivery date is calculated. In step 242, the system displays a order summary to the purchaser. Further, in step 244, an order confirmation number is provided to the purchaser.

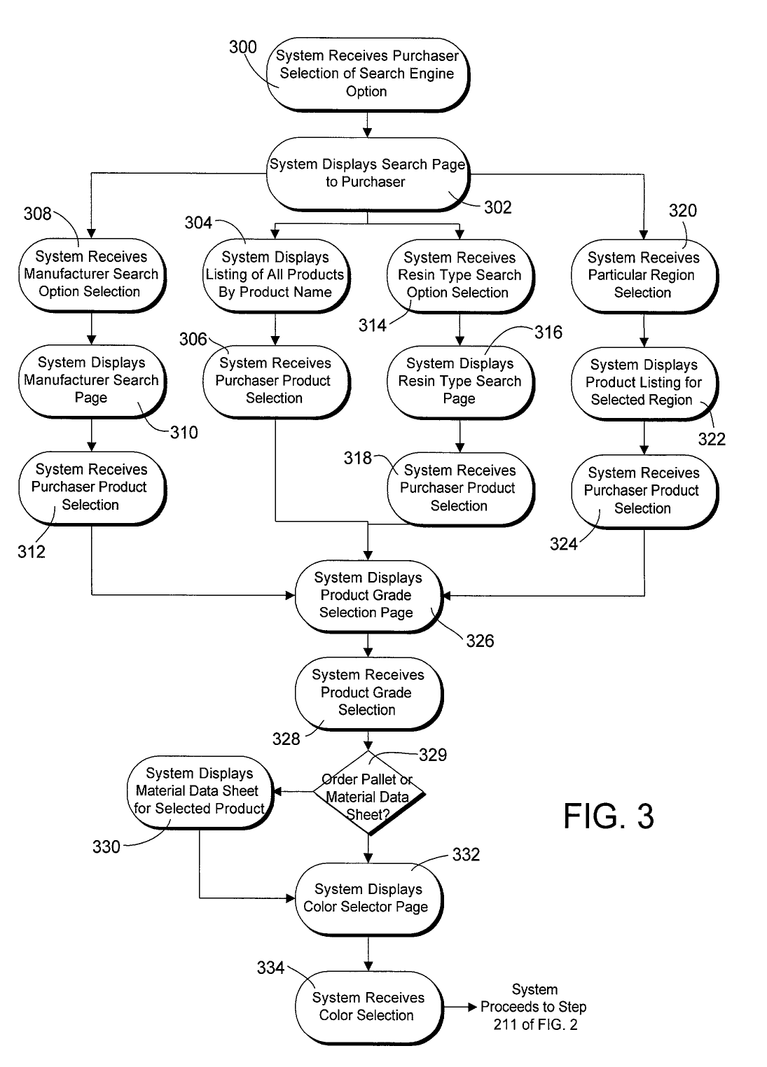

Referring now to FIG. 3, there is shown a flow chart describing one preferred embodiment of the search engine option briefly described in step 209 above. In step 300, the system receives a purchaser selection of a search engine option. In response, the system, in step 302, displays a search page to the purchaser. Included on the search page is a default search option as well as several alternative search options. In a preferred embodiment, purchasers would be initially provided with a product name search interface as well as options to search using 1) a manufacturer name, 2) a particular resin type, or 3) a particular region.

In step 304, the system displays a listing of all products sold on the site by product name. Preferably, this listing is in the form of a scrollable menu. In step 306, the system receives a purchaser request to add a selected material to their shopping cart. Returning to step 302, if the purchaser decides to search for materials by the manufacturer name search option, the system in step 308, receives a purchaser selection of a manufacturer name search option. In response, the system, in step 310, displays a manufacturer search page. Preferably, the manufacturer search page includes a two part interface for facilitating product location in the manner set forth in detail below.

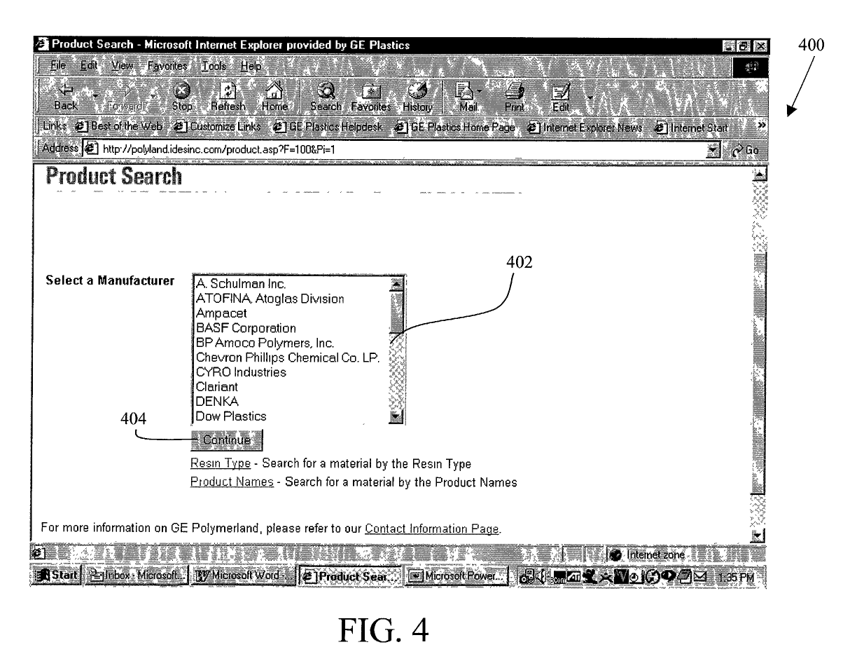

Referring now to FIG. 4, there is shown a preferred embodiment of a web page 400 for use with the manufacturer search option. Preferably, web page 400 includes a manufacturer name field 402 and a continue button 404. Initially, the manufacturer name field 402 is populated with a listing of all manufacturer's names whose products are sold on the site. Upon selection of a particular manufacturer's name in field 402, and clicking of the continue button 404, a new web page is shown including a listing of product names available from the selected manufacturer. The purchaser then selects a particular product and selects to add the product to their shopping cart. If the user does not choose to add the product to their order pallet, they may clear their manufacturer name/product name selections.

In an alternative embodiment, both a manufacturer name field and a product name field may be included on a single web page. In this embodiment, the product name field is initially unpopulated prior to a selection of a particular manufacturer. At this time, the product name field would become populated with products available from the selected manufacturer.

Returning to FIG. 3, once a purchase selects a particular product, the system, in step 312 receives a purchaser selection to add the product to the order pallet. Returning, once again to step 302, if the purchaser selects to search for a product using the resin type search option, the system, in step 314, receives a purchaser selection of a resin type search option. In response, the system, in step 316, displays a resin type search page. Preferably, the resin type search page includes a two part interface for facilitating product location similar to that set forth above for the manufacturer name search option.

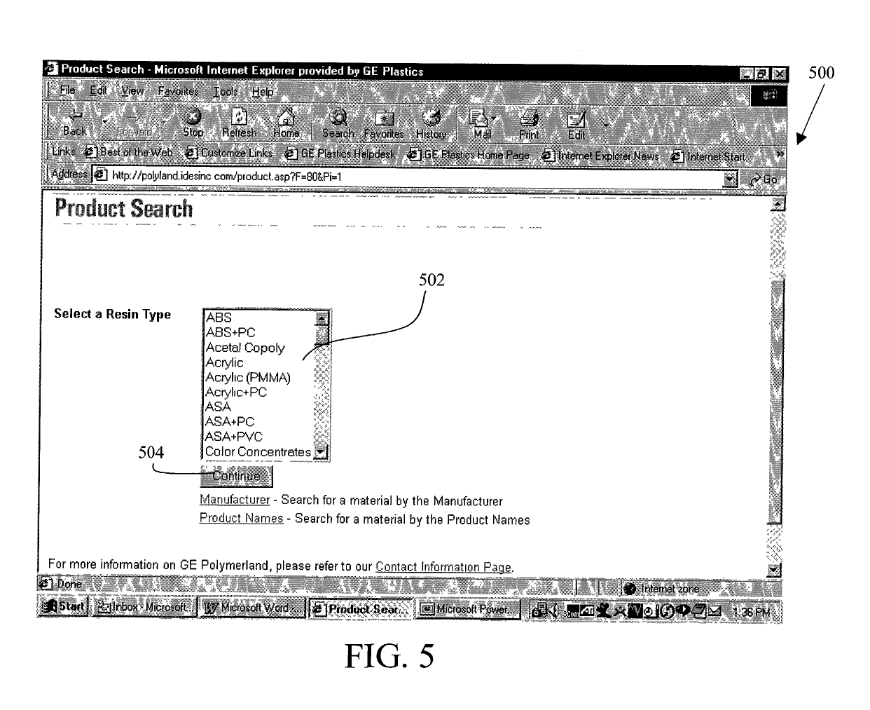

Referring now to FIG. 5, there is shown a preferred embodiment of a web page 500 for use with the resin type search option. Preferably, web page 500 includes a resin type generic name field 502 and a continue button 504. Initially, the resin type generic name field 502 is populated with a listing of all resin types sold on the site. Upon selection of a particular resin type in field 502, and clicking of the continue button 504, a new web page is shown including a listing of product names available matching the selected resin type. The purchaser then selects a particular product and selects to add the product to their shopping cart. If the user does not choose to add the product to their order pallet, they may clear their manufacturer name/product name selections.

In an alternative embodiment similar to that described above, both a resin type generic name field and a product name field may be included on a single web page. In this embodiment, the product name field is initially unpopulated prior to a selection of a particular resin type. At this time, the product name field would become populated with products available matching the selected resin type.

Returning to FIG. 3, once a purchase selects a particular product, the system, in step 318 receives a purchaser selection to add the product to the order pallet. Returning, once again to step 302, if the purchaser selects to search for a product using the region search option, the system, in step 320, receives a purchaser selection of a particular region to search. Preferably, the available regions include the USA, Mexico, Canada, and Caribbean. In response, the system, in step 322, displays a regions specific listing of available products. In a preferred embodiment, the region specific listing of available products is listed in order of Manufacturer and preferably includes a graphical logo for each respective manufacturer. The purchaser can then search through the available products for a particular product to purchase.

Returning to FIG. 3, once a purchaser selects a particular product, the system, in step 324 receives a purchaser selection to add the product to the shopping cart. Once the purchaser has selected a particular product to add to the shopping cart using one of the four methods detailed above, the system, in step 326, displays a product grade selection page to the purchaser. Preferably, the product grade selection page includes a listing of all of the available product grades for the selected product. Each available grade may include several varieties of the selected product.

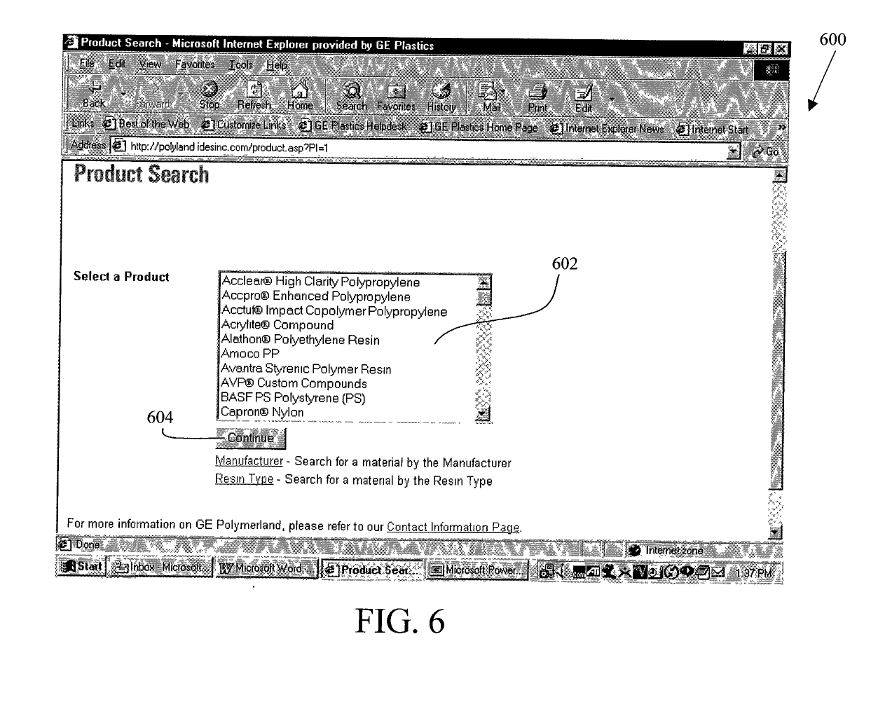

Referring now to FIG. 6, there is shown a preferred embodiment of a web page 600 for use with the product name search option. Preferably, web page 600 includes a product name field 602 and a continue button 604. The product name field 602 is preferably populated with an alphabetical listing of all resin types sold on the site. Upon selection of a particular product name in field 602, and clicking of the continue button 604, the purchaser selects to add the product to their shopping cart. If the user does not choose to add the product to their order pallet, they may clear their manufacturer name/product name selections.

In an alternative embodiment, purchasers may select a product name by grade. Initially, the web page includes an alphabetical listing of product names broken down by grade. By selecting a particular grade, the purchaser is moved to the relevant portion of the page where all varieties of the selected product in that grade are displayed. This embodiment of the web page further includes options to add the selected product to an order pallet and an option to view a material data sheet for the product.

Returning to FIG. 3, once the purchaser selects a particular variety of product in step 327, the system, in step 328, receives a purchaser selection of either an add to order pallet option or a view material data sheet option. If the system receives a view material data sheet option, the system, in step 330, displays an electronic version of the official material data sheet associated with the selected product. Preferably, the material data sheet includes a variety of specific information relating to the product's qualities, capabilities, and specifications. The material data sheet further includes an add to order pallet option. Once the system receives an add to order pallet selection from the purchaser (either from step 328 or 330), the system, in step 332, displays a color selector page to the purchaser. In this page, a listing of available colors for the selected product is displayed to the user. In step 334, the system receives a purchaser selection of a particular color and advances to step 211 of the order entry process described in detail above for order entry completion.

It should be understood that, although the searching methods described above are described in relation to the general order entry process of FIG. 2, these methods may be applied to any type of online scenario such as product look up requests, etc. Further, the invention can be applied to purchasing systems or any other systems in which products must be searched. In addition, various hardware and software can be used to implement the invention. As described above, the computer network of the present invention can be the Internet or any other communication channel permitting the appropriate data to be communicated between computers.

By providing a search capability for enabling purchasers to more easily and quickly locate particular products using several distinct search methods, the ordering of bulk materials, such as chemicals, is greatly improved. Further, by enabling purchasers to locate products by product name, manufacturer name, resin type, or region, purchasers having different levels and types of knowledge are more easily able to locate and order the desired products.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A method for enabling searching for products over a computer network, comprising:
receiving, from a client computer system associated with a purchaser, a request to search for an product;
displaying a plurality of search options to the purchaser;
receiving a purchaser request of a selected search option;
displaying a search page associated with the selected search option, wherein said search page includes a listing of products listed in accordance with the selected search option; and
receiving a purchaser selection of a particular product listed on said search page.

2. The method of claim 1, wherein said plurality of search options include a product name search option.

3. The method of claim 2, further comprising the steps of:
receiving a purchaser selection of the product name search option;
displaying a product name search page, wherein the product name search page includes at least a listing of available products; and
receiving a purchaser selection of the particular product from said listing of available products.

4. The method of claim 1, wherein said plurality of search options include a manufacturer search option.

5. The method of claim 4, further comprising the steps of:
receiving a purchaser selection of the manufacturer search option;
displaying a manufacturer search page, wherein the manufacturer search page includes an initial listing of manufacturers whose products are available;
receiving a purchaser selection of a selected manufacturer;
displaying a listing of products produced by the selected manufacturer; and
receiving a purchaser selection of the particular product from the listing of products produced by the selected manufacturer.

6. The method of claim 5, wherein said initial listing of manufacturers whose products are available is an alphabetical listing.

7. The method of claim 1, wherein said plurality of search options include a resin type search option.

8. The method of claim 7, further comprising the steps of:
receiving a purchaser selection of the resin type search option;
displaying a resin type search page, wherein the resin type search page includes an initial listing of resin types that are available;
receiving a purchaser selection of a selected resin type;
displaying a listing of products falling under the selected resin type; and
receiving a purchaser selection of the particular product from the listing of products falling under the selected resin type.

9. The method of claim 1, wherein said plurality of search options include a region search option.

10. The method of claim 9, further comprising the steps of:
displaying a plurality of regions to the purchaser;
receiving a purchaser selection of a particular region;
displaying a listing of products available in the particular region; and
receiving a purchaser selection of the particular product from the listing of products available in the particular region.

11. The method of claim 10, wherein said listing of products available in the particular region is a listing of available products sorted alphabetically by manufacturer.

12. The method of claim 11, wherein said listing of products available includes graphical logos for each manufacturer.

13. The method of claim 1, further comprising the steps of:
displaying, to the purchaser, a product grade page associated with the particular product, wherein the product grade page includes a listing of all grades of the particular product available for purchase; and
receiving a purchaser selection of a selected product grade from the listing of all grades of the particular product.

14. The method of claim 13, further comprising the steps of:
displaying, on said product grade page, a view material data sheet option for each listed grade of the particular product;
receiving a purchaser selection of the view material data sheet option for a selected product grade; and
displaying, to the purchaser, a material data sheet for the selected product grade.

15. The method of claim 1, further comprising the steps of:
displaying a listing of colors available for the particular product; and
receiving a selection of a particular color.

16. A computer readable storage medium incorporating instructions for enabling online searching of products, comprising:
one or more instructions for receiving, from a client computer system associated with a purchaser, a request to search for an product;
one or more instructions for displaying a plurality of search options to the purchaser;
one or more instructions for receiving a purchaser request of a selected search option;
one or more instructions for displaying a search page associated with the selected search option, wherein said search page includes a listing of products listed in accordance with the selected search option; and
one or more instructions for receiving a purchaser selection of a particular product listed on said search page.

17. The storage medium of claim 16, wherein said plurality of search options include a product name search option.

18. The storage medium of claim 17, further comprising:
one or more instructions for receiving a purchaser selection of the product name search option;
one or more instructions for displaying a product name search page, wherein the product name search page includes at least a listing of available products; and
one or more instructions for receiving a purchaser selection of the particular product from said listing of available products.

19. The storage medium of claim 16, wherein said plurality of search options include a manufacturer search option.

20. The storage medium of claim 19, further comprising:
one or more instructions for receiving a purchaser selection of the manufacturer search option;
one or more instructions for displaying a manufacturer search page, wherein the manufacturer search page includes an initial listing of manufacturers whose products are available;
one or more instructions for receiving a purchaser selection of a selected manufacturer;
one or more instructions for displaying a listing of products produced by the selected manufacturer; and
one or more instructions for receiving a purchaser selection of the particular product from the listing of products produced by the selected manufacturer.

21. The storage medium of claim 20, wherein said initial listing of manufacturers whose products are available is an alphabetical listing.

22. The storage medium of claim 16, wherein said plurality of search options include a resin type search option.

23. The storage medium of claim 22, further comprising:
one or more instructions for receiving a purchaser selection of the resin type search option;
one or more instructions for displaying a resin type search page, wherein the resin type search page includes an initial listing of resin types that are available;
one or more instructions for receiving a purchaser selection of a selected resin type;
one or more instructions for displaying a listing of products falling under the selected resin type; and
one or more instructions for receiving a purchaser selection of the particular product from the listing of products falling under the selected resin type.

24. The storage medium of claim 16, wherein said plurality of search options include a region search option.

25. The storage medium of claim 24, further comprising:
one or more instructions for displaying a plurality of regions to the purchaser;
one or more instructions for receiving a purchaser selection of a particular region;
one or more instructions for displaying a listing of products available in the particular region; and
one or more instructions for receiving a purchaser selection of the particular product from the listing of products available in the particular region.

26. The storage medium of claim 25, wherein said listing of products available in the particular region is a listing of available products sorted alphabetically by manufacturer.

27. The storage medium of claim 26, wherein said listing of products available includes graphical logos for each manufacturer.

28. The storage medium of claim 16, further comprising:
one or more instructions for displaying, to the purchaser, a product grade page associated with the particular product, wherein the product grade page includes a listing of all grades of the particular product available for purchase; and
one or more instructions for receiving a purchaser selection of a selected product grade from the listing of all grades of the particular product.

29. The storage medium of claim 28, further comprising:
one or more instructions for displaying, on said product grade page, a view material data sheet option for each listed grade of the particular product;
one or more instructions for receiving a purchaser selection of the view material data sheet option for a selected product grade; and
one or more instructions for displaying, to the purchaser, a material data sheet for the selected product grade.

30. The storage medium of claim 16, further comprising:
one or more instructions for displaying a listing of colors available for the particular product; and
one or more instructions for receiving a selection of a particular color.
